(19) United States
(12) Patent Application Publication
(10) Pub. No.: US 2014/0089215 A1
(43) Pub. Date: Mar. 27, 2014

(54) CONFINING USE OF CONTENT TO A DEVICE

(71) Applicant: HEWLETT-PACKARD DEVELOPMENT COMPANY, L.P., Houston, TX (US)

(72) Inventors: Oscar A. Montemayor, San Jose, CA (US); David Donahue, HalfMoon Bay, CA (US)

(73) Assignee: Hewlett-Packard Development Company, L.P., Houston, TX (US)

(21) Appl. No.: 13/629,525

(22) Filed: Sep. 27, 2012

(51) Int. Cl. G06Q 99/00

(52) U.S. Cl. 705/318

(57) ABSTRACT

Disclosed herein are a system, non-transitory computer-readable medium, and method for confining content. A digital receipt is generated in response to a request for content. An identifier associated with the remote device sending the request is included in the digital receipt such that use of the content is confined to the remote device.

### BACKGROUND

Online consumers obtain or purchase electronic products such as streaming or downloaded movies, video games, or upgrades to video games originally downloaded for free. Such content may be downloaded from an application in the device (e.g. in-application purchase), an application catalog, or some other content providing service. Other digital content may be free of charge, but may be proprietary content requiring authorization before access to the content is granted.

### BRIEF DESCRIPTION OF THE DRAWINGS

FIG. 1 is an example system in accordance with aspects of the disclosure.

FIG. 2 is an alternate example of the system shown in FIG. 1.

FIG. 3 is a flow diagram of an example method in accordance with aspects of the disclosure.

FIG. 4 is a working example in accordance with aspects of the disclosure herein.

### DETAILED DESCRIPTION

As noted above, digital content such as movies or video game upgrades may be purchased and downloaded to a device. However, once downloaded, such content may be susceptible to access by unauthorized users. For example, the content may be readily copied to multiple devices, even if a consumer paid for one copy or license. As such, movies or video games purchased from an online merchant may result in copyright violations. Such violations may be difficult or even impossible for a merchant to trace. Furthermore, online purchase systems may be required to authorize online purchases each time the content is accessed on a device. Thus, online purchase systems may require constant maintenance to keep up with demand.

In view of the foregoing, aspects of the present disclosure provide techniques for confining content to a device. In one aspect, a digital receipt may be generated in response to a request for content. An identifier associated with the remote device sending the request is included in the digital receipt such that use of the content is confined to the remote device. The identifier associated with the device may prevent the content from being operative on an unauthorized device, even if the receipt and the content are copied thereto. Furthermore, the digital receipt may enable the remote device to validate the receipt each time a user requests access to the content. This relieves online purchase systems from validating every request for access to electronic content already downloaded on a device. The aspects, features and advantages of the disclosure will be appreciated when considered with reference to the following description of examples and accompanying figures. The following description does not limit the disclosure; rather, the scope of the disclosure is defined by the appended claims and equivalents.

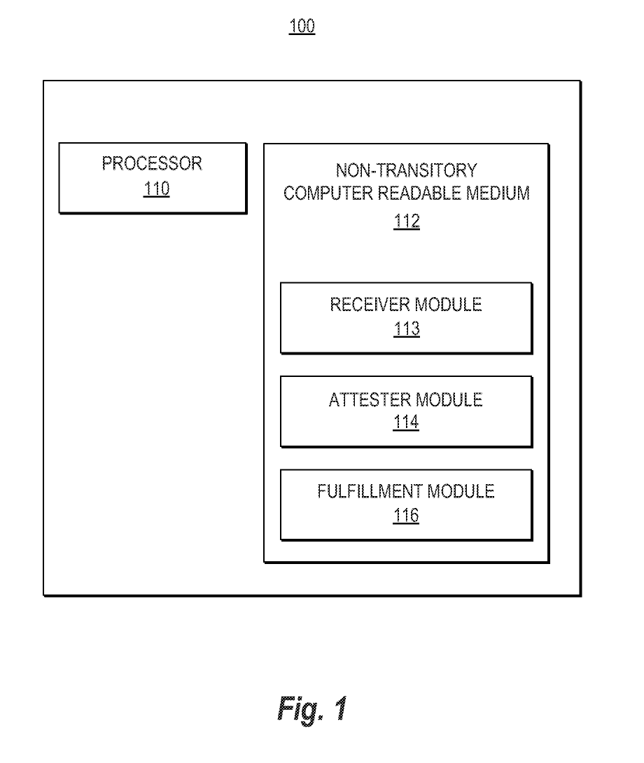

FIG. 1 presents a schematic diagram of an illustrative computer apparatus 100 that may be used to execute the techniques disclosed herein. Computer apparatus 100 may comprise any device capable of processing instructions and transmitting data to and from other computers, including a laptop, a full-sized personal computer, a high-end server, or a network computer lacking local storage capability. Computer apparatus 100 may include all the components normally used in connection with a computer. For example, it may have a keyboard, a mouse and/or various other types of input devices such as pen-inputs, joysticks, buttons, touch screens, etc., as well as a display, which could include, for instance, a CRT, LCD, plasma screen monitor, TV, projector, etc.

The computer apparatus 100 may also contain a processor 110, which may be any number of well known processors, such as processors from Intel® Corporation. In another example, processor 110 may be an application specific integrated circuit (“ASIC”). Non-transitory computer readable medium (“CRM”) 112 may store instructions that may be retrieved and executed by processor 110. As will be discussed in more detail below, the instructions may include a receiver module 113, an attester module 114, and a fulfillment module 116. In one example, non-transitory CRM 112 may be used by or in connection with any instruction execution system, such as computer apparatus 100, that can fetch or obtain the logic from non-transitory CRM 112 and execute the instructions contained therein. Non-transitory computer readable media may comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, a portable compact disc or other storage devices that may be coupled to computer apparatus 100 directly or indirectly. Alternatively, non-transitory CRM 112 may be a random access memory (“RAM”) device or may be divided into multiple memory segments organized as dual in-line memory modules (“DIMMs”). The non-transitory computer-readable medium (“CRM”) 112 may also include any combination of one or more of the foregoing and/or other devices as well.

The instructions stored in non-transitory CRM 112 may comprise any set of instructions to be executed directly (such as machine code) or indirectly (such as scripts) by the processor(s). In that regard, the terms “instructions,” “modules” and “programs” may be used interchangeably herein. The instructions may be stored in any computer language or format, such as in object code or modules of source code. Furthermore, it is understood that the instructions may be implemented in the form of hardware, software, or a combination of hardware and software and that the examples herein are merely illustrative.

Receiver module 113 may handle requests for an electronic product or digital content. In one example, the request comprises an identifier associated with the remote device sending the request. Attester module 114 may generate a digital receipt or attestation in response to the request, if it is determined that the remote device is authorized to receive the electronic product. Furthermore, attester module 114 may include the identifier in the digital receipt such that use of the electronic product or digital content is confined to the remote device associated with the identifier. Fulfillment module 116 may validate the digital receipt and provide the electronic product to the remote device, if the digital receipt is valid, such that the electronic product is operative in the remote device when the digital receipt resides therein.

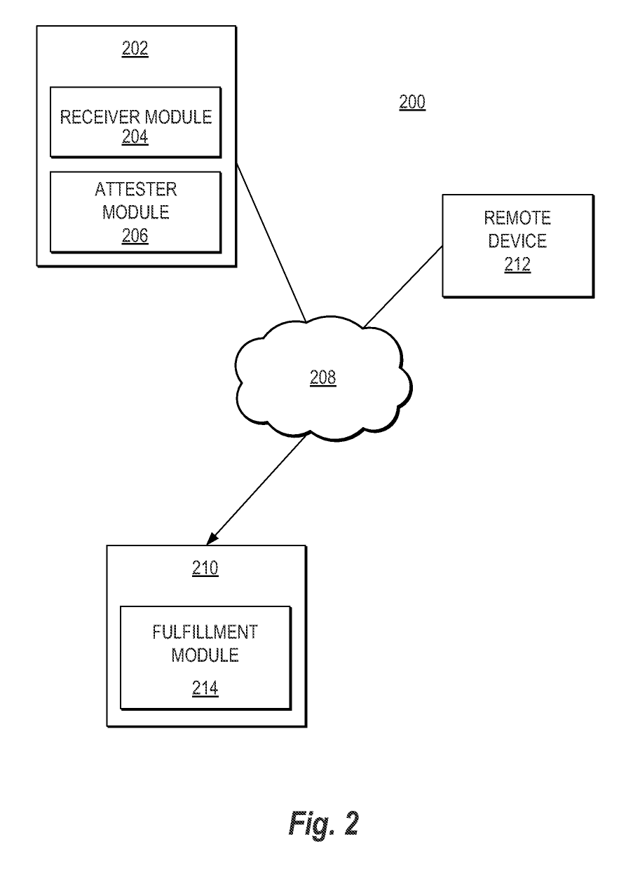

Although FIG. 1 functionally illustrates one processor and one non-transitory CRM as being within the same block, it will be understood that these components may actually comprise at least one or multiple processors and memories that may or may not be stored within the same physical housing. For example, any one of the memories may be a hard drive or other storage media located in a server farm of a data center. Accordingly, references to a processor, computer, or memory will be understood to include references to a collection of processors, computers, or memories that may or may not operate in parallel. Furthermore, receiver module 113, attester module 114, and fulfillment module 116 may reside on different computers or may be associated with different entities. For example, FIG. 2 shows an alternate configuration of the modules. FIG. 2 shows computer apparatus 202, computer apparatus 210, and remote device 212 in a networked configuration. Each computer apparatus or device shown in FIG. 2 may be similarly configured to computer apparatus 100 of FIG. 1. In a further example, remote device 212 may be a mobile device capable of wirelessly exchanging data with a server, such as a mobile phone, a wireless-enabled PDA, or a tablet PC.

Receiver module 204 and attester module 206 are shown executing in computer apparatus 202. Computer apparatus 202 may be associated with, for example, a payment processing system of an online merchant. Attester module 206 may cryptographically sign or encrypt a digital receipt or attestation using a public and private key pair. Such key pairs may be generated and managed by a key management provider (e.g., Verisign, Komodo, etc.). Computer apparatus 210 is shown hosting a fulfillment module 214, which may comprise a third party validation system to verify the digital attestation or receipt. Remote device 212 may provide the digital receipt or attestation to fulfillment module 214.

If attester module 206 uses public and private key encryption, fulfillment module 214 may perform an online public key verification check using, for example, online certificate status protocol (“OCSP”). Such verification may be performed to ensure the public and private key pair has not been compromised. In one example, the pair may be compromised when the private key is obtained by unauthorized users. If it is determined that the public and private key pair is compromised (e.g., the OCSP verification fails), a request for an alternate digital receipt or attestation may be sent to attester module 206. Attester module 206 may generate and provide an alternate digital receipt or attestation in response thereto and include the identifier associated with the remote device therewith. If fulfillment module 214 determines that the digital receipt is valid, it may provide the electronic product or digital content to remote device 212. The modules shown in FIG. 2 may communicate via a network 208 that may comprise a local area network (“LAN”), wide area network (“WAN”), the Internet, etc. and may be wired or wireless. It should be understood that the arrangement of FIG. 2 is merely illustrative and that different arrangements may be configured.

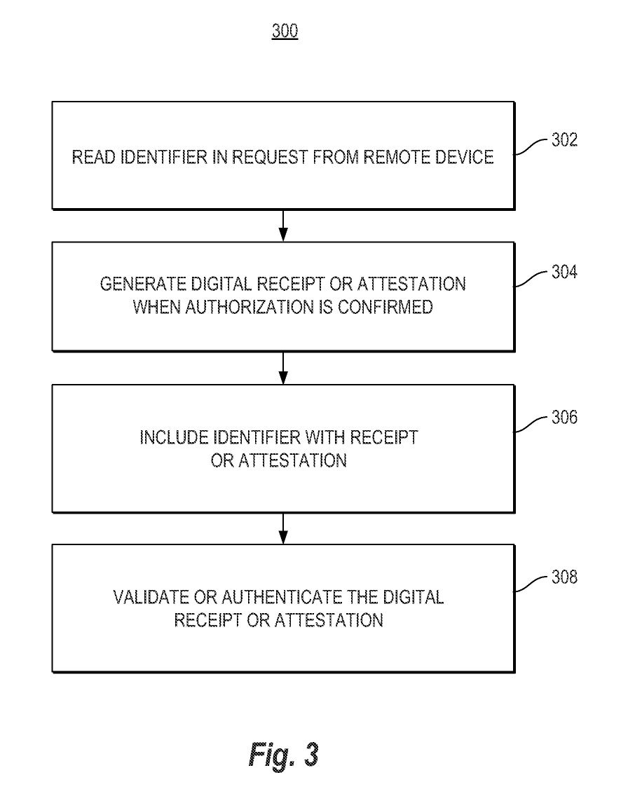

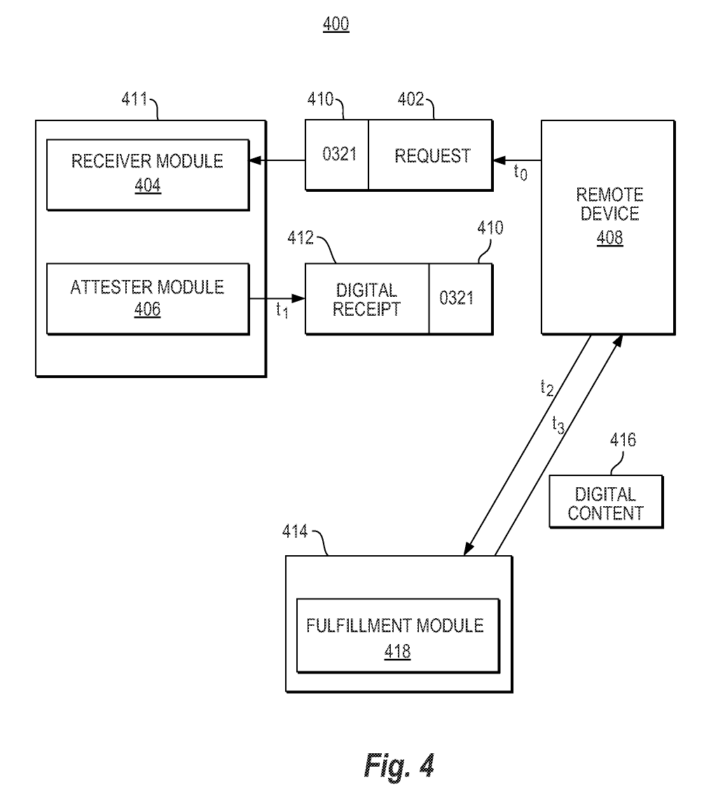

One working example of a system and method for confining content is illustrated in FIGS. 3-4. In particular, FIG. 3 is a flow diagram of an example method in accordance with aspects of the present disclosure. FIG. 4 presents various aspects of confining content in accordance with the techniques disclosed herein. The actions shown in FIG. 4 will be discussed below with regard to the flow diagram of FIG. 3.

As shown in block 302 of FIG. 3, an identifier associated with a remote device may be read. FIG. 4 illustrates data that may be stored within computer apparatus 411, computer apparatus 414, and remote device 408. The computer apparatus and device shown in FIG. 4 may be similarly configured to those shown in FIG. 2. Remote device 408 is shown sending a request 402 for digital content or an electronic product to receiver module 404 at time t₀. The request is shown having an identifier 410 that may uniquely identify remote device 408. The identifier may be, for example, a serial number associated with the device. Referring back to FIG. 3, a digital receipt or attestation may be generated, when it is confirmed that the remote device is authorized to receive the requested content, as shown in block 304. Authorization may be confirmed, for example, when payment for the digital content or electronic product is executed. In another example, authorization may be confirmed when the user of the remote device establishes membership to a certain affiliation that grants him/her access to the digital content or electronic product.

In block 306, the identifier associated with the remote device may be included with the digital receipt or attestation. As noted above, this identifier may uniquely identify the remote device such that access to the digital content or electronic product is confined to the device. As such, the digital content or electronic product may be inoperative if copied to another device. Furthermore, the digital content or electronic product may be inoperative on another device even if the digital receipt is also copied thereto. The identifier included in the receipt may ensure that the content is operative in the device authorized to receive the content.

Referring back to FIG. 4, attester module 406 is shown generating a digital receipt 412 with the identifier 410, at time t₁. The identifier may be pre-pended or appended to the digital receipt or inserted therein. Referring back to FIG. 3, the digital receipt may be validated or authenticated, as shown in block 308. In FIG. 4, at time t₂, the digital receipt 412 may be presented to fulfillment module 418 in a request for transmission of the electronic content. As noted above, fulfillment module 418 may comprise a trusted third party server that may be utilized to verify the public and private keys used to cryptographically sign the digital receipt or attestation. If the public and private key pair used to cryptographically sign the digital receipt or attestation is valid, fulfillment module 418 may provide the digital content 416 to remote device 408 at time t₃. When the digital receipt is validated, the digital or electronic content may be operative in remote device 408 as long as the digital receipt or attestation resides in the remote device. Otherwise, access to the digital content may be prohibited. The digital receipt 412 may also enable remote device 408 to validate the digital receipt therein, when a user requests to use the digital content or electronic product. Thus, rather than validating the receipt online each time access to the digital content is requested, the validation may occur locally in the device, which allows the system to scale indefinitely as online purchases continue to increase.

Advantageously, the above-described system, method, and non-transitory computer readable medium prevent digital content from being activated in unauthorized devices. In this regard, online merchants of digital content can avoid any adversity resulting from unauthorized copies thereof pervading the digital market. Thus, encounters with copyright violations can be avoided. Furthermore, the techniques disclosed herein eliminate the need to scale the purchase system to accommodate higher volume of online purchases, since validation of purchases may be carried out locally on the device.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein. Rather, processes may be performed in a different order or concurrently, and steps may be added or omitted.

1. A system comprising:
one or more processors;
a receiver module executable on at least one of the one or more processors to handle a request for an electronic product, the request comprising an identifier associated with a remote device sending the request;
an attester module executable on at least one of the one or more processors to generate a digital receipt in response to the request, if the remote device is authorized to receive the electronic product, and to include the identifier with the digital receipt such that use of the electronic product is confined to the remote device associated with the identifier; and
a fulfillment module executable on at least one of the one or more processors to validate the digital receipt and provide the electronic product to the remote device in response to the validating indicating that the digital receipt is valid, such that the electronic product is operative in the remote device when the digital receipt resides in the remote device.

2. The system of claim 1, wherein the attester module is executable to encrypt the digital receipt using a public and private key pair.

3. The system of claim 2, wherein the attester module is executable to generate and provide an alternate digital receipt, in response to determining that the public and private key pair has been compromised.

4. The system of claim 1, wherein the digital receipt enables the remote device to validate the digital receipt at the remote device in response to a user request to use the electronic product in the remote device.

5. The system of claim 1, wherein the fulfillment module is executable to validate the digital receipt using an online certificate status protocol.

6-7. (canceled)

8. A non-transitory computer-readable medium with instructions stored therein which, if executed, cause at least one processor to:
read an identifier in a request for digital content, the identifier being associated with a remote device transmitting the request;
generate a digital attestation that confirms the remote device is authorized to receive the digital content;
include the identifier with the digital attestation such that access to the digital content is confined to the remote device associated with the identifier;
validate the digital attestation such that the digital content is operative in the remote device, when the digital attestation resides therein;
encrypt the digital attestation using a public and private key pair; and
generate an alternate digital attestation, if it is determined that the public and private key pair has been compromised.

9. The non-transitory computer-readable medium of claim 8, wherein the digital attestation enables the remote device to validate the digital attestation at the remote device in response to a user request to use the digital content in the remote device.

10. The non-transitory computer-readable medium of claim 8, wherein the instructions stored therein, if executed, further cause at least one processor to validate the digital attestation using an online certificate status protocol.

11. A method comprising:
detecting, by at least one processor, an identifier included in a request from a remote device for electronic content, the identifier being associated with the remote device;
generating, by at least one processor, a digital receipt, when it is determined that the remote device is authorized to receive the electronic content;
including, by at least one processor, the identifier with the digital receipt such that use of the electronic content is confined to the remote device associated with the identifier;
determining, by at least one processor, whether the digital receipt is authentic, when a request for transmission of the electronic content is received from the remote device; and
sending, by at least one processor, the electronic content to the remote device, in response to determining that the digital receipt is authentic, such that the electronic content is operative in the remote device, when the digital receipt resides at the remote device.

12. The method of claim 11 further comprising encrypting, by at least one processor, the digital receipt using a public and private key pair.

13. The method of claim 12 further comprising, generating, by at least one processor, an alternate digital receipt, response to determining that the public and private key pair has been compromised.

14. The method of claim 11, wherein the digital receipt enables the remote device to validate the digital receipt at the remote device in response to a user request to use the electronic content in the remote device.

15. The method of claim 11 further comprising, validating, by at least one processor, the digital receipt using an online certificate status protocol.

16. The non-transitory computer-readable medium of claim 8, wherein the instructions stored therein, if executed, further cause at least one processor to:
send the digital content from a fulfillment module to the remote device in response to the validating indicating that the digital attestation is valid.
